(19) United States
(12) Patent Application Publication
(10) Pub. No.: US 2008/0067802 A1
(43) Pub. Date: Mar. 20, 2008

(54) Self-laminating label for a wristband

(75) Inventors: Jeremy P. Bell, Durand, MI (US); Robert J. Antcliff, Okemos, MI (US)

Correspondence Address: Christopher J. Fildes;Fildes & Outland, P.C., Suite 2, 20916 Mack Avenue, Grosse Pointe Woods, MI, 48236, US

(73) Assignee: Tri-State Hospital Supply Corporation

(21) Appl. No.: 11/509,409

(22) Filed: Aug. 24, 2006

(51) Int. Cl. B42D 15/00

(52) U.S. Cl. 283/81

(57) ABSTRACT

A self-laminating label is mountable on a medical wristband. The label includes a print panel having a printable upper surface and an adhesive lower surface. The lower surface is adhereable to a top surface of the wristband. The back panel is contiguously attached to the print panel along a longitudinal first boundary. The back panel has an adhesive lower surface adhereable to a bottom surface of the wristband upon being folded along the first boundary and around a first edge of the wristband. A transparent lamination panel is contiguously attached to the back panel along a longitudinal second boundary. The lamination panel has an adhesive lower surface sized to adhere to and laminate the printable surface of the first panel upon being folded along the second boundary and around a second edge of the wristband.

### TECHNICAL FIELD

This invention relates to patient labels and more particularly to a self-laminating label for a patient's wristband.

### BACKGROUND OF THE INVENTION

In the medical and surgical fields, patient identification wristbands are routinely applied to a patient's wrist. These wristbands can display a variety of patient medical information, such as blood type or allergies to medications, etc.

Wristbands with pre-printed areas for identifying patients have been described in a number of prior art patents and are well known in the art. However, it is often more convenient and advantageous to provide separate wristband labels, which can be pre-printed or edited in the field and remotely adhered to the wristband. Problematically, such separate labels are not easily laminated, and often smudge when they come in contact with chemicals or body fluids.

Additionally, it is often desirable to have the wristband labels combined with other labels carrying related patient information, such as labels for the patient's Intravenous (IV) bag. However, if the different labels are stored in a loose assortment, valuable time may be lost in hunting and finding the proper label for the particular application involved.

### SUMMARY OF THE INVENTION

The present invention provides a self-laminating wristband label, which provides patient identification information and additionally protects the identification information under a laminated transparent panel. The present invention also provides a label sheet upon which the self-laminating label and a plurality of associated non-laminated labels can be securely stored, efficiently transported, and imprinted with related patient information.

In an exemplary embodiment of the present invention, a self-laminating label is mountable on a medical wristband. The label includes an elongated print panel having a printable upper surface and an adhesive lower surface. The adhesive lower surface is adhereable to a top surface of the wristband. The label also includes an elongated back panel contiguously attached to the print panel along a first foldable longitudinal boundary. The back panel has an adhesive lower surface adhereable to a bottom surface of the wristband upon being folded along the first boundary and around a first edge of the wristband. An elongated transparent lamination panel of the self-laminating label is contiguously attached to the back panel along a second foldable longitudinal boundary. The lamination panel has an adhesive lower surface sized to adhere to and laminate the printable surface of the first panel upon being folded along the second boundary and around a second edge of the wristband.

In another exemplary embodiment, a label sheet includes a release liner, a self-laminating label for a medical wristband, and a plurality of non-laminated labels. The self-laminating label is releaseably attached to the release liner. The label has a print panel, a back panel and a lamination panel. The elongated print panel has a printable upper surface and an adhesive lower surface. The adhesive lower surface is adhereable to a top surface of the wristband. The elongated back panel is contiguously attached to the print panel along a first foldable longitudinal boundary. The back panel has an adhesive lower surface adhereable to a bottom surface of the wristband upon being folded along the first boundary and around a first edge of the wristband. The elongated transparent lamination panel is contiguously attached to the back panel along a second foldable longitudinal boundary. The lamination panel has an adhesive lower surface sized to adhere to and laminate the printable surface of the first panel upon being folded along the second boundary and around a second edge of the wristband. The non-laminated labels are also releaseably attached to the release liner.

These and other features and advantages of the invention will be more fully understood from the following detailed description of the invention taken together with the accompanying drawings.

### BRIEF DESCRIPTION OF THE DRAWINGS

In the drawings:

FIG. 1 is a plan view of an exemplary embodiment of a label sheet having a self-laminating label in accordance with the present invention;

FIG. 2 is a cross-sectional view of the self-laminating label of FIG. 1 wrapped around a wristband; and

FIG. 3 is a perspective view of the self-laminating label wrapped around the wristband of FIG. 2.

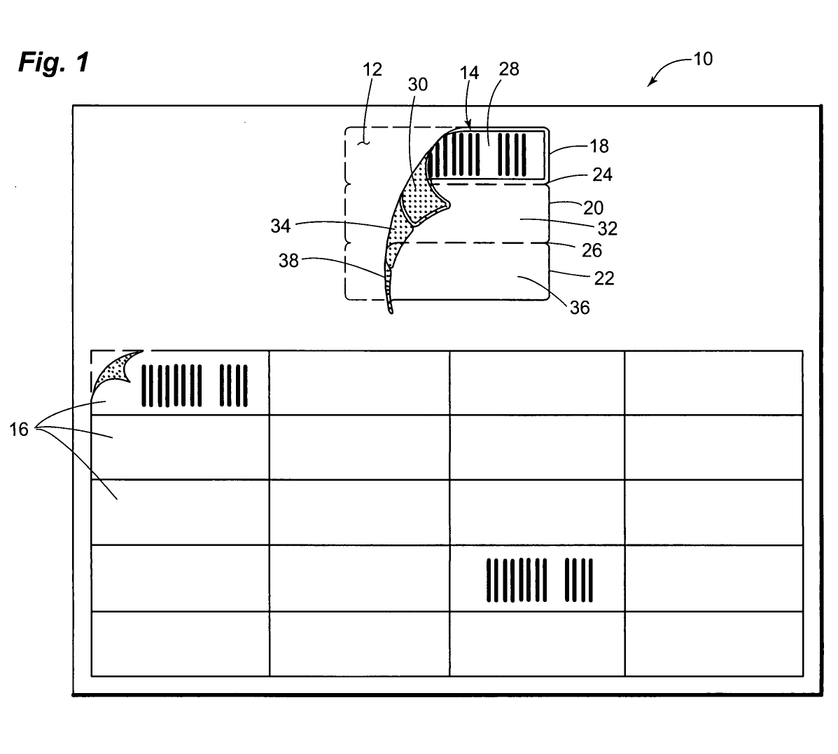

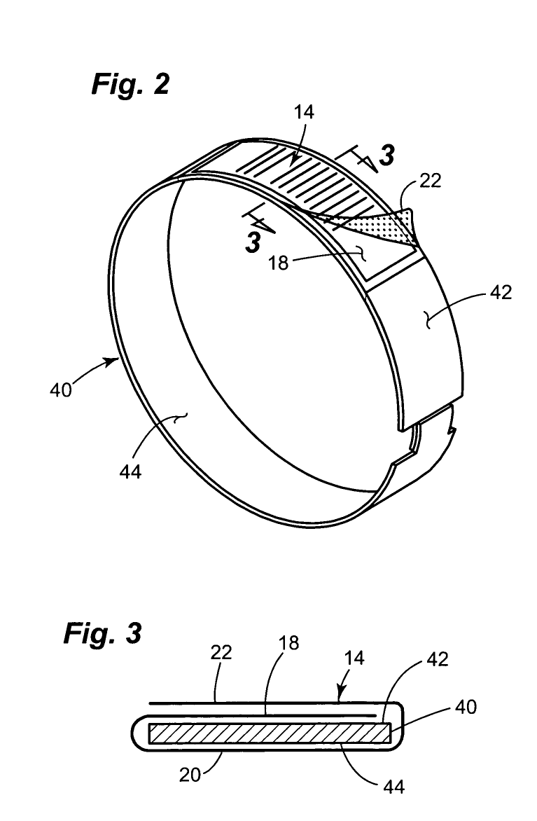

### DETAILED DESCRIPTION OF THE INVENTION

Referring to the drawings in detail, numeral 10 generally indicates an exemplary embodiment of a label sheet in accordance with the present invention. The label sheet 10 includes a release liner 12, upon which a self-laminating label 14 and a plurality of associated non-laminated labels 16 are releaseably attached.

Self-laminating label 14 includes a print panel 18, a back panel 20 and a lamination panel 22, which are contiguously attached and foldable along first and second longitudinal boundaries 24 and 26.

The generally rectangular elongated print panel 18 has a printable upper surface 28 and a lower surface 30, which is coated with a pressure sensitive adhesive. The adhesive is such that it is releaseably adhereable to the release liner 12, but permanently adhereable to a top surface of a typical medical wristband 40.

The print panel 18 is composed of a printable material, such as paper, card stock, plastic or the like. Appropriate identification information is printed on the upper surface 28 such as the patient's name and/or a bar code that identifies the patient. The identification information may be pre-printed on the upper surface 28 utilizing a variety of machine printing technologies, such as ink jet printing, laser printing or the like. Alternatively, the information may be printed on print panel 18 by hand with pen, pencil or other similar writing instrument.

The generally rectangular elongated back panel 20 is contiguously attached to the print panel 18 along the first foldable longitudinal boundary 24. The back panel 20 also has an upper surface 32 and a lower surface 34, which is coated with a pressure sensitive adhesive. The pressure sensitive adhesive on lower surface 34 may be the same as the adhesive on lower surface 30 so long as it is releaseably adhereable to the release liner 12 and permanently adhereable to the back side of a typical medical wristband 40. The back panel 20 can be any appropriate flexible material and/or color, but in this embodiment it is preferably a clear laminate, which provides protection when applied to the wristband 40.

The lamination panel 22 also has a generally rectangular elongated shape and is contiguously attached to the back panel 20 along the second foldable longitudinal boundary 26. The lamination panel 22 has an upper surface 36 and a lower surface 38, which is also coated with a pressure sensitive adhesive. The adhesive on lower surface 38 is preferably the same as the adhesive on the lower surfaces 30 and 34. However, the adhesive on surface 38 must releaseably adhere to release liner 12 and permanently adhere to the upper surface 28 of print panel 18. The lamination panel 22 is composed of a clear flexible laminate material, which is sized to adhere to and laminate the printable upper surface 28 of the print panel 18 when applied thereto.

The self-laminating label 14 is stored with its adhesive coated lower surfaces 30, 34 and 38 releaseably attached and disposed upon the release liner 12 of label sheet 10. Upon application, the label 14 is peeled off the release liner 12 and wrapped around a typical medical wristband 40.

More particularly, a patient's identification information is first either pre-printed by machine or written by hand onto the printable upper surface 28 of the print panel 18 of self-laminating label 14. The label 14 is then peeled from the release liner 12 of label sheet 10. Next, the adhesive coated lower surface 30 of print panel 18 is pressed against the top surface 42 of wristband 40 to secure the print panel 18 to the wristband 40 with the upper surface 28 containing the patient's identification information facing upwards. Back panel 20 is then folded down and around the wristband 40 at the first longitudinal boundary 24 so that the back panel's 20 adhesive coated lower surface 34 presses against and securely adheres to the bottom surface 44 of the wristband. Next, the lamination panel 22 is folded up and around the wristband 40 so that the lamination panel's 22 adhesive coated lower surface 38 adheres to and laminates the printable upper surface 28 of print panel 18.

The remaining non-laminated labels 16 can contain related information for the patient that is either pre-printed by machine or printed by hand in the field. The labels can be utilized to identify equipment or medical information to be used in the care of the particular patient identified by the label 14. For example, the patient's blood type can be written on a label 16 and placed upon the patient's IV bag.

The self-laminating label 14 and associated non-laminated labels 16 of label sheet 10 provide an efficient system of identification and information display that can be customized to a particular patient. The label sheet prevents individual labels from being lost or damaged during transport to a patient's bedside. Additionally, the self-laminating feature of the label 14 protects the important patient identification information from being smudged or damaged if the wristband should come in contact with bodily fluids or other liquids during the patient's treatment.

In an alternative embodiment, the label sheet 10 may include a plurality of self-laminating labels 14 having the features described above. The plurality of self-laminating labels 14 are releaseably attached to the release liner 12 of the sheet 10. In this embodiment, the label sheet 10 may also include one or more of the non-laminated labels 16.

Although the invention has been described by reference to specific embodiments, it should be understood that numerous changes may be made within the spirit and scope of the inventive concepts described. Accordingly, it is intended that the invention not be limited to the described embodiments, but that it have the full scope defined by the language of the following claims.

What is claimed is:

1. A self-laminating label mountable on a medical wristband, the label comprising:
an elongated print panel having a printable upper surface and an adhesive lower surface, said adhesive lower surface adhereable to a top surface of said wristband;
an elongated back panel contiguously attached to said print panel along a first foldable longitudinal boundary, said back panel having an adhesive lower surface adhereable to a bottom surface of said wristband upon being folded along said first boundary and around a first edge of said wristband; and
an elongated transparent lamination panel contiguously attached to said back panel along a second foldable longitudinal boundary, said lamination panel having an adhesive lower surface sized to adhere to and laminate said printable surface of said first panel upon being folded along said second boundary and around a second edge of said wristband.

2. The self-laminating label of claim 1 wherein said back panel is transparent.

3. The self-laminating label of claim 1 wherein said adhesive lower surfaces are coated with a pressure sensitive adhesive.

4. The self-laminating label of claim 1 wherein said lamination panel comprises a flexible transparent film.

5. The self-laminating label of claim 4 wherein said back panel comprises a flexible transparent film.

6. The self-laminating label of claim 1 wherein said self-laminating label is releasably disposed upon a printable label sheet.

7. A label sheet comprising:
a release liner;
a self-laminating label for a medical wristband releaseably attached to said release liner, said label having:
an elongated print panel having a printable upper surface and an adhesive lower surface, said adhesive lower surface adhereable to a top surface of said wristband,
an elongated back panel contiguously attached to said print panel along a first foldable longitudinal boundary, said back panel having an adhesive lower surface adhereable to a bottom surface of said wristband upon being folded along said first boundary and around a first edge of said wristband, and
an elongated transparent lamination panel contiguously attached to said back panel along a second foldable longitudinal boundary, said lamination panel having an adhesive lower surface sized to adhere to and laminate said printable surface of said first panel upon being folded along said second boundary and around a second edge of said wristband; and
a plurality of non-laminated labels releaseably attached to said release liner.

8. The label sheet of claim 7 wherein said self-laminating label is contiguously attached to said sheet along a weakened boundary wherein said label is separable from said sheet at said boundary.

9. The label sheet of claim 8 wherein said weakened boundary surrounds a perimeter of said self-laminating label.

10. The label sheet of claim 7 wherein said lamination panel comprises a flexible transparent film.

11. The label sheet of claim 10 wherein said back panel comprises a flexible transparent film.

12. The label sheet of claim 7 having a self-laminating label portion and a non-laminated label portion, wherein said self-laminating label portion is contiguous with said non-laminated label portion along a boundary.
